(19) United States
(12) Patent Application Publication
(10) Pub. No.: US 2012/0044357 A1
(43) Pub. Date: Feb. 23, 2012

(54) Image processing apparatus and method for night vision

(75) Inventors: Kyoung Joong Min, Seoul (KR); Ho Seop Jeong, Seongnam (KR); In Taek Song, Seongnam (KR); Tae Hyeon Kwon, Gwangmyeong (KR); Gyu Won Kim, Suwon (KR)

(73) Assignee: SAMSUNG ELECTRO-MECHANICS CO., LTD., Suwon (KR)

(21) Appl. No.: 13/064,954

(22) Filed: Apr. 28, 2011

(30) Foreign Application Priority Data
Aug. 19, 2010 (KR) 10-2010-0080537

(51) Int. Cl. H04N 5/33

(52) U.S. Cl. 348/164; 348/E05.09

(57) ABSTRACT

There are provided an image processing apparatus and an image processing method for night vision that can generate a night vision image in which the overall quality thereof is maintained to be excellent and an obstacle is easily distinguished. The image processing apparatus for night vision includes: a brightness improving unit improving the brightness of an inputted infrared image; an obstacle judging unit judging whether an obstacle is present by analyzing an infrared image in which brightness is improved by the brightness improving unit; an obstacle region separating unit separating an image of a region judged as the obstacle by the obstacle judging unit; and an image synthesizing unit synthesizing the image of the region judged as the obstacle separated by the obstacle region separating unit with the inputted infrared image.

### CROSS-REFERENCE TO RELATED APPLICATIONS

This application claims the priority of Korean Patent Application No. 10-2010-0080537 filed on Aug. 19, 2010, in the Korean Intellectual Property Office, the disclosure of which is incorporated herein by reference.

### BACKGROUND OF THE INVENTION

1. Field of the Invention

The present invention relates to a night vision apparatus, and more particularly, to an image processing apparatus and an image processing method for night vision that can generate a night vision image to facilitate distinguishing an obstacle while maintaining excellent overall image quality.

2. Description of the Related Art

In recent years, a night vision system for preventing a collision with an on-coming obstacle occurring during night driving has been actively researched and developed as a system for preventing traffic accidents and improving driver convenience.

A general night vision system using near infrared rays may include an infrared ray radiator emitting infrared rays to the front of a vehicle, an image sensor for detecting infrared rays inputted from in front of the vehicle, and a processor (a digital signal processor (DSP) or an image signal processor (ISP)) for improving the quality of the detected image outputted from the image sensor and judging whether an obstacle included in the detected image exists or not.

In the general night vision system, the infrared-ray radiator and the infrared-ray image sensor are used to acquire an image in a darkened night environment; however, it is difficult to intuitively judge the presence of an obstacle through only the acquired image itself, due to device performance constraints. Accordingly, an image processing algorithm is applied to the image acquired from the image sensor by using the processor.

An apparatus that implements an image processing algorithm adopted in a known night vision system may include a noise reducing circuit (a low pass filter) for removing noise from the image acquired from the image sensor, an edge region improving circuit extracting an edge element and adding the extracted edge element to the image in order to improve the definition of the image, and a brightness improving unit (histogram equalizer) improving the brightness of the image in order to distinguish an object or an obstacle in a dark region. In such a known night vision system, the brightness improving unit, improving a dark image so as to be bright, improves the dark region of the image so as to be bright yet deteriorates the overall quality of the entire image by increasing even noise included in the image. As such, in known night vision systems, the quality of a final output image is deteriorated due to noise which is increased in improving the brightness of the dark image.

### SUMMARY OF THE INVENTION

An aspect of the present invention provides an image processing apparatus and an image processing method for night vision that can prevent the overall quality of an image from being deteriorated due to an increase in noise while improving judgment and visibility of an obstacle.

According to an aspect of the present invention, there is provided an image processing apparatus for night vision, the apparatus including: a brightness improving unit improving brightness of an inputted infrared image; an obstacle judging unit judging whether an obstacle is present by analyzing an infrared image in which brightness is improved by the brightness improving unit; an obstacle region separating unit separating an image of a region judged as the obstacle by the obstacle judging unit; and an image synthesizing unit synthesizing the image of the region judged as the obstacle separated by the obstacle region separating unit with the inputted infrared image.

The apparatus may further include an image preprocessing unit removing noise of the inputted infrared image and emphasizing an edge region thereof.

The infrared image outputted by the image preprocessing unit may be inputted into the brightness improving unit.

The apparatus may further include a buffer unit receiving the inputted infrared image, delaying the infrared image for a predetermined time and outputting the infrared image.

The image synthesizing unit may synthesize the image of the region judged as the obstacle separated by the obstacle region separating unit with the infrared image outputted to the buffer unit.

The apparatus may further include an image preprocessing unit removing noise of the inputted infrared image and emphasizing an edge region thereof.

The infrared image outputted by the image preprocessing unit may be inputted into the buffer unit and the brightness improving unit.

According to another aspect of the present invention, there is provided an image processing method for night vision, the method including: improving brightness of an inputted infrared image; judging whether an obstacle is present by analyzing an infrared image in which brightness is improved in the improving of the brightness; separating an image of a region judged as the obstacle in the judging; and synthesizing the image of the region judged as the obstacle separated in the separating with the inputted infrared image.

The method may further include removing noise of the inputted infrared image and emphasizing an edge region thereof.

In the improving of the brightness, the brightness of the infrared image in which noise is removed and the edge region is emphasized may be improved.

The method may further include receiving the inputted infrared image and delaying the infrared image for a predetermined time.

In the synthesizing, the image of the region judged as the obstacle separated in the separating may be synthesized with the infrared image delayed in the delaying.

The method may further include removing noise of the inputted infrared image and emphasizing an edge region thereof.

In the improving of the brightness, the brightness of the infrared image in which noise is removed and the edge region is emphasized may be improved, and in the delaying, the infrared image in which noise is removed and the edge region is emphasized may be delayed for the predetermined time.

### BRIEF DESCRIPTION OF THE DRAWINGS

The patent or application file contains at least one drawing executed in color. Copies of this patent or patent application publication with color drawing (s) will be provided by the Office upon request and payment of the necessary fee.

The above and other aspects, features and other advantages of the present invention will be more clearly understood from the following detailed description taken in conjunction with the accompanying drawings, in which:

FIG. 1 is a block diagram of an image processing apparatus for night vision according to an exemplary embodiment of the present invention; and

FIGS. 2 through 4 are exemplary diagrams for the comparison of an input infrared image which is not subjected to image processing, an infrared image which is subjected to known image processing, and an infrared image to which an image processing method for night vision according to an exemplary embodiment of the present invention is applied.

### DETAILED DESCRIPTION OF THE PREFERRED EMBODIMENT

Exemplary embodiments of the present invention will now be described in more detail with reference to the accompanying drawings. The present invention is not limited to the exemplary embodiments and the exemplary embodiments are merely used to help in understanding the spirit of the present invention. Like reference numerals refer to like elements in the accompanying drawings.

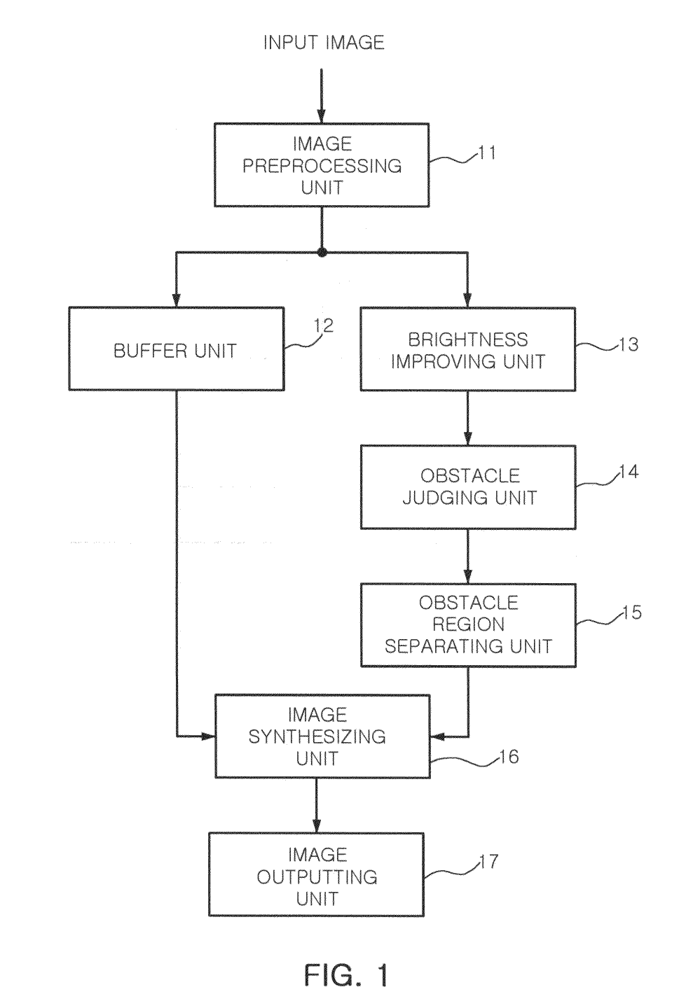

FIG. 1 is a block diagram of an image processing apparatus for night vision according to an exemplary embodiment of the present invention.

As shown in FIG. 1, the image processing apparatus for night vision according to the exemplary embodiment of the present invention may include a brightness improving unit 13, an obstacle judging unit 14, an obstacle region separating unit 15, and an image synthesizing unit 16.

In addition, the exemplary embodiment of the present invention may optionally include an image preprocessing unit 11, a buffer unit 12, and an image outputting unit 17.

The image preprocessing unit 11 may perform image processing for suppressing a noise element and image processing for strengthening an edge element for an infrared image inputted from an image sensor. The image preprocessing unit 11 may include a low pass filter (LPF) for suppressing the noise element and a high pass filter (HPF) detecting the edge element for strengthening the edge element.

The brightness improving unit 13 may improve the brightness of the inputted infrared image or the brightness of the infrared image in which noise is suppressed and the edge element is strengthened through the image preprocessing unit 11. In the infrared image used for night vision, a very dark region and a very bright region are definitely separated from each other. For example, a region to which the lighting of a vehicle is irradiated or a region in which a street lamp is present is displayed very brightly, while the remainder of a background region is displayed very darkly due to night pick-up conditions. In order to judge the obstacle region, the brightness of the infrared image needs to be improved due to characteristics of the infrared image.

In general, the brightness improving process applied to the brightness improving unit 13 may be performed by a histogram equalizer that analyzes a histogram of the inputted infrared image and rearranges the brightness of the image. Since a contrast ratio may be deteriorated after the brightness improving process is performed through the rearrangement of the histogram, the brightness improving unit 13 may adopt the brightness improving process and image processing for improving the contrast ratio of the infrared image.

The obstacle judging unit 14 judges whether an obstacle is present in the infrared image in which the brightness is improved by the brightness improving unit 13. A judgment algorithm of the obstacle region applied to the obstacle judging unit 14 may adopt various obstacle detecting algorithms known in the art.

The obstacle region separating unit 15 separates an image of a region judged as the obstacle by the obstacle judging unit 14 from the infrared image in which brightness is improved. The obstacle region separating unit 15 may set a quadrangular image region including the part judged as the obstacle, and extract information (a pixel coordinate, a color value of a pixel, and the like) regarding pixels included in the set image region.

The image synthesizing unit 16 synthesizes the obstacle region image, separated by the obstacle region separating unit 15, with the inputted infrared image or the infrared image in which noise is suppressed and the edge element is strengthened by the image preprocessing unit 11 to thereby generate an output image.

The image synthesizing unit 16 may receive the pixel information of the quadrangular image region including the obstacle from the obstacle region separating unit 15 and apply the information regarding the pixels to the infrared image inputted from the image sensor or the infrared image in which noise is suppressed and the edge element is strengthened by the image preprocessing unit 11 to thereby synthesize the images.

In order to couple the obstacle region image to the infrared image inputted from the image sensor or the infrared image in which noise is suppressed and the edge element is strengthened by the image preprocessing unit 11, the buffer unit 12 for delaying the infrared image inputted from the image sensor or the infrared image in which noise is suppressed and the edge element is strengthened by the image preprocessing unit 11 may be required while the image processing for extracting the obstacle region is performed. The buffer unit 12 may be implemented by a line buffer or a frame buffer that receives the infrared image inputted from the image sensor or the infrared image in which noise is suppressed and the edge element is strengthened by the image preprocessing unit 11 and delays them for a predetermined time, and outputs them as they are.

According to the image processing apparatus for night vision according to the exemplary embodiment of the present invention, an image processing method for night vision can be implemented through data flow among the components included in the image processing apparatus for night vision. That is, according to the block diagram of the image processing apparatus for night vision shown in FIG. 1, since steps of the image processing method for night vision according to the present invention can be apparently implemented, an additional figure for the image processing method will be omitted.

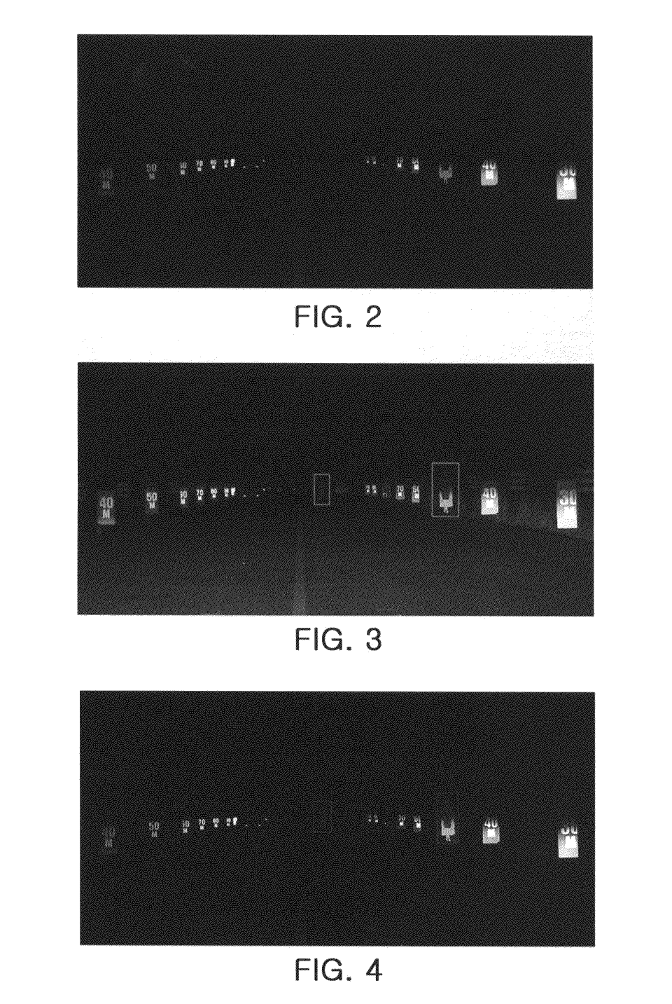

FIGS. 2 to 4 are exemplary diagrams for the comparison of an input infrared image which is not subjected to image processing, an infrared image which is subjected to known image processing, and an infrared image to which an image processing method for night vision according to an exemplary embodiment of the present invention is applied.

As shown in FIG. 2, in an infrared image inputted from an image sensor, a region in which reflections are produced by lighting is displayed brightly and the rest region is displayed merely by a black image. Accordingly, it is not easy to judge an obstacle by only the infrared image shown in FIG. 2, and there is a high probability of failure in judging the presence of an obstacle.

Meanwhile, as shown in FIG. 3, in the case in which image processing for improving brightness is applied to the entire infrared image of the image sensor shown in FIG. 2, it is easier to verify the presence of an obstacle. The infrared image of FIG. 3 may be regarded as an image outputted from the brightness improving unit 13 in the image processing apparatus for night vision of the present invention. In particular, an obstacle positioned in the center of the infrared image, which is not shown in FIG. 2, may be shown. However, the image of FIG. 3 creates visual distraction, because even the brightness of parts other than the obstacle is unnecessarily improved and noise is seriously generated in a part corresponding to a road surface or the sky, such that a user's visibility is remarkably deteriorated.

The present invention judges the obstacle by using the image of FIG. 3 outputted from the brightness improving unit 13, separates an image (an image of a quadrangular region in FIG. 3) of a region corresponding to the obstacle, and synthesizes the separated image with the infrared image shown in FIG. 2. As a result, an image shown in FIG. 4 is generated.

FIG. 4 shows an output infrared image to which the image processing method for night vision according to the exemplary embodiment of the present invention has been applied. In FIG. 4, an unnecessary part other than the obstacle or a region whose image quality is deteriorated due to noise is not shown by using an infrared image in which brightness is not improved in parts corresponding to a background. Further, only the region corresponding to the obstacle may be displayed brightly by applying the image separated from the image in which brightness is improved as the region corresponding to the obstacle.

As set forth above, the quality of the entire image can be prevented from being deteriorated due to an increase of noise by improving the brightness of an infrared image detected from an image sensor, and separating only a region judged as an obstacle from an infrared image inwhich brightness is improved, synthesizing the corresponding region with an infrared image in which brightness is not improved and generating an output image. Further, the visibility of the obstacle can be improved by displaying only the obstacle region to be brighter in a dark background.

While the present invention has been shown and described in connection with the exemplary embodiments, it will be apparent to those skilled in the art that modifications and variations can be made without departing from the spirit and scope of the invention as defined by the appended claims. Accordingly, the scope of the present invention will be determined by the appended claims.

What is claimed is:

1. An image processing apparatus for night vision, the apparatus comprising:
a brightness improving unit improving brightness of an inputted infrared image;
an obstacle judging unit judging whether an obstacle is present by analyzing an infrared image in which brightness is improved by the brightness improving unit;
an obstacle region separating unit separating an image of a region judged as the obstacle by the obstacle judging unit; and
an image synthesizing unit synthesizing the image of the region judged as the obstacle separated by the obstacle region separating unit with the inputted infrared image.

2. The apparatus of claim 1, further comprising:
an image preprocessing unit removing noise of the inputted infrared image and emphasizing an edge region thereof,
wherein the infrared image outputted by the image preprocessing unit is inputted into the brightness improving unit.

3. The apparatus of claim 1, further comprising:
a buffer unit receiving the inputted infrared image, delaying the infrared image for a predetermined time, and outputting the infrared image,
wherein the image synthesizing unit synthesizes the image of the region judged as the obstacle separated by the obstacle region separating unit with the infrared image outputted to the buffer unit.

4. The apparatus of claim 3, further comprising:
an image preprocessing unit removing noise of the inputted infrared image and emphasizing an edge region thereof,
wherein the infrared image outputted by the image preprocessing unit is inputted into the buffer unit and the brightness improving unit.

5. An image processing method for night vision, the method comprising:
improving brightness of an inputted infrared image;
judging whether an obstacle is present by analyzing an infrared image in which brightness is improved in the improving of the brightness;
separating an image of a region judged as the obstacle in the judging; and
synthesizing the image of the region judged as the obstacle separated in the separating with the inputted infrared image.

6. The method of claim 5, further comprising:
removing noise of the inputted infrared image and emphasizing an edge region thereof,
wherein, in the improving of the brightness, the brightness of the infrared image in which noise is removed and the edge region is emphasized is improved.

7. The method of claim 5, further comprising:
receiving the inputted infrared image and delaying the infrared image for a predetermined time,
wherein, in the synthesizing, the image of the region judged as the obstacle separated in the separating is synthesized with the infrared image delayed in the delaying.

8. The method of claim 7, further comprising:
removing noise of the inputted infrared image and emphasizing an edge region thereof,
wherein, in the improving of the brightness, the brightness of the infrared image in which noise is removed and the edge region is emphasized is improved, and
in the delaying, the infrared image in which noise is removed and the edge region is emphasized is delayed for the predetermined time.
